(19) United States
(12) Patent Application Publication
(10) Pub. No.: US 2005/0261037 A1
(43) Pub. Date: Nov. 24, 2005

(54) Conservation of battery power in mobile devices having communication capabilities

(76) Inventors: Mandayam T. Raghunath, Fishkill, NY (US); Chandrasekhar Narayanaswami, Wilton, CT (US)

Correspondence Address: David Aker, 23 Southern Road, Hartsdale, NY, 10530, US

(21) Appl. No.: 10/848,301

(22) Filed: May 18, 2004

(51) Int. Cl. H04Q 7/20

(52) U.S. Cl. 455/574; 455/572; 455/421

(57) ABSTRACT

A method, apparatus and computer program product that in a mobile data communications system having at least one base station, at least one beacon and at least one mobile device, enables the mobile devices to conserve power. A wireless communication subsystem in each mobile device communicates with the base station. A beacon either signals the presence of a main base station or the need for the mobile device to attempt to associate or communicate with the base station. A beacon detection circuit in a mobile device activates the wireless communication subsystem in the mobile device when the beacon is received by the beacon detection circuit, which may be a passive circuit using no power, or a very low power receiver.

### FIELD OF THE INVENTION

This invention relates to mobile communications devices. More particularly, it relates to such devices and systems used to communicate data between base stations and a mobile device, and to the conservation of battery power in such mobile devices.

### BACKGROUND OF THE INVENTION

One significant problem with small portable devices is getting data into and out of them easily. From the perspective of usability, it is highly desirable to accomplish this data transfer without using wires and connectors. Two of the common approaches to wireless data transfer are line of sight such as Infrared communication and radio-frequency communication such as 802.11, Bluetooth and Ultrawide band.

Infrared communication is usually directional; the devices communicating with each other must usually be pointed at each other and the path between the devices must be free of opaque obstructions. Radio-frequency communication on the other hand tends to be omnidirectional and can tolerate obstructions. As a result RF communication tends to be preferred over IR especially when the communication must occur without the active involvement of the user of the device in question.

A significant problem with respect to RF communication is the amount of energy required for communication. Since most mobile devices are usually powered by a low capacity energy source such as a battery, conserving battery power becomes imperative.

By way of example, a specific instance of such a mobile device is an intelligent wrist watch. However, a mobile device in accordance with the invention may be any one of a PDA, a cell phone, or a combination of the two such as a Blackberry® device.

An intelligent wrist watch may be powered by a rechargeable battery and may be equipped with both IR and RF communication capabilities. Multiple RF communication technologies may be used on the same device to reduce power consumption. The main ideas discussed here apply to efficient use of energy by the main RF communication module on the wrist watch, or any mobile data communication device.

On the wrist watch, RF communication is used to deliver alerts to the watch. For instance, when the user receives an urgent e-mail message, the name of the sender and the message subject is sent to the watch over RF from an RF base station that is in the vicinity of the watch. The distance between the watch and the base station could range from less than a meter to hundreds of kilometers depending on the RF technology used. Once the RF communication module receives the message it acknowledges the message to the base station and alerts the user, perhaps by sounding the buzzer on the watch and displaying the message on the watch face.

Energy usage in the above RF communication scenario can be broadly classified into energy for transmit and energy for receive. In order for the watch to acknowledge receipt of the message, it must send an acknowledgment to the base station. In order to send this acknowledgment, it must supply energy to the RF transmitter in the watch which radiates part of the energy out from an antenna. The radiated power must be adequate to be received at the antenna of the base station. One way of reducing this energy requirement (for transmit) is to limit the range of communication to short distances. The shorter the distance the less the amount of energy required. Another way of reducing the energy for transmit is to reduce the amount of data that is transmitted, in other words, limiting the “acknowledgment” to a small number of bits.

On the other hand, energy required for receive is generally lower than that for transmit. Energy consumed in receive primarily consists of energy consumed by circuits that detect incoming signals at the antenna and circuits that amplify the incoming signal and extract useful information from the incoming signal. However, energy required for receive tends to add up over time because the receiver is usually on for more time than the transmitter. The transmitter needs to be powered on only when the watch has data to send. However, since the watch has no way of knowing when the base station will want to send it an alert message, the receiver generally needs to be powered on all the time. This is wasteful of precious battery resources.

In the past, the following approaches have been used to save energy in RF receive:

1. Operate the receiver on some polling duty cycle: The receiver is not on all the time. Instead the receiver comes on at some regular interval and stays on for a short duration. For instance the receiver could come on once every minute and stay on for a period of 5 seconds. In this way, the average energy requirement of the receiver can be reduced by the duty factor. In this particular example, the energy would be cut down by a factor of 12 since the receiver is on for only 1/12th of the time. Typically the base station and the receiver negotiate a polling interval and the base station and the receiver agree on precise times when they will exchange data. The base station should ensure that it sends data for a particular watch only during the portion of the cycle when the receiver of that particular watch is on.

2. Activate the receiver in response to user action: The receiver is normally off. It comes on when the user initiates some explicit action. An example of this approach is used by the Palm VII. The RF unit is powered on only when the user raises the antenna. While this approach is more efficient than the earlier one because it avoids unnecessary polling operations, this approach requires active involvement of the user in the communication process. The user will not receive an alert unless and until the receiver is started, effectively rendering the alert mechanism much less useful because receiving messages requires explicit actions on the part of the user.

### SUMMARY OF THE INVENTION

The present invention addresses the issue of saving energy in the receive portion of the RF communication module.

The present inventors have recognized that what is needed a way to save energy in the receive portion of the RF communication circuitry to improve the battery life. It is desirable to design schemes where a mobile device can leave its receiver turned off most of the time to save energy. However such schemes must still allow the user to receive information asynchronously from the infrastructure easily and effortlessly.

In accordance with the invention, the RF receiver module may be equipped with auxiliary technologies that can be used to signal the mobile device to turn on the main RF communication module. Examples of auxiliary technology include passive circuitry, i.e., circuitry that does not need any battery power (e.g., RFID), or a lower power RF technology such as an FM receiver.

In this invention passive auxiliary technology may include hardware which detects an RF signal and charges up a capacitor. When the watch is brought to the vicinity of a base station a beacon signal radiated by the base station is detected by the passive circuitry which charges the capacitor. The charge on the capacitor signals the processor on the watch that it is within range of a base station and the processor then powers on the main RF receiver to check if there is indeed an incoming message. Using this approach, the main RF receiver can be off whenever the mobile device is out of range of a base station and comes on only when it comes into the proximity of a base station. If the user is walking around a building and there are base stations at certain locations in the building, the receiver will come on only when the user gets close to the base stations. At other times, since the user is out of range of the base station, the RF receiver stays off.

If the user simply stops near a base station, the passive circuitry indicates that the watch is continuously in the vicinity of a base station. In this case, the watch negotiates a polling interval with the base station and operates its receiver on a polling duty cycle as discussed above.

If the device is low on battery power, the device may drop into an explicit user initiated RF communication mode, while still using the information provided by the RF detection circuitry. In particular, when the beacon signal is detected by the RF signal detection circuitry, the device tells the user that he or she is in the vicinity of a base station, but the user must turn on the RF module explicitly, or charge the battery since the battery is low (or connect to an external energy supply).

An additional enhancement includes decoding the beacon signal and comparing the address it contains with the address of the mobile device. If the address in the beacon does not match its address, the device makes no attempt to turn on the main RF communication link. In addition the beacon can signal when the device's main RF communication link needs to be turned on.

One of the problems with the RF detection circuitry is that it generally requires the base station to radiate a significant amount of energy, perhaps more than that required during normal communication with the watch. Another problem is that RF noise may trigger the RF detection circuitry resulting in false triggers to the watch. One way of dealing with this is to equip the base station with the ability to radiate a burst of energy in a specific frequency within the band at periodic intervals. The RF detection circuitry can be tuned to listen to just this particular frequency with a very narrow filter around the frequency.

It is therefore an aspect of the present invention to provide a mobile device that communicates with a base station, but that conserves energy while doing so.

It is a further aspect of the invention to provide a system for the utilization of mobile devices that communicate with base stations, wherein the mobile devices conserve energy.

In another aspect of this invention, a lower power active RF technology can be used to signal to the device to turn on the main RF communication module.

The device constantly listens on the auxiliary channel and determines if the messages are addressed to it. If so the device parses the message and determines the time at which the main communication channel should be turned on. The signal message may include at least one of several parameters such as the time at which the main channel should be turned on, the location of the main base station, the location from where the beacon is broadcast, the duration for which the channel should be kept on, authentication parameters such as public keys or other keys that may be needed for further communication on the main channel, etc.

Thus, the invention is directed to a mobile data communications system having at least one base station and at least one mobile device, comprising a wireless communication subsystem in each mobile device for communicating with the at least one base station, a beacon for signaling at least one of a presence of a base station and a need for a mobile device to associate or communicate with a base station; and a beacon detection circuit in a mobile device for performing at least one of activating the wireless communication subsystem in the mobile device, and alerting a user of the mobile device to conduct communication with a base station, when the beacon is received by the beacon detection circuit.

Preferably, the beacon has a range less than that of the wireless communication subsystem, and the wireless communication subsystem is activated when the mobile device is in proximity to a location of a beacon. The beacon may transmit data indicative of a class of mobile devices to which messages are to be sent. The beacon range may be larger than that of the wireless communication subsystem, and may provide an indication of the particular mobile devices to which a message is to be sent. The beacon may comprise a signal transmitted by one of a broadcast station, satellite radio channels, and a cell phone base station, with the beacon detection circuit being configured for receiving the signal. The beacon detection circuit may comprise a passive detection circuit for converting energy received from the radio frequency transmitter to a logic signal. The passive detection circuit may comprise an antenna, a passive energy converter, and a capacitor for storing energy from the passive energy converter.

The beacon may comprise a transmitter for transmitting a radio frequency transmission at multiple frequencies and the beacon detection circuit may comprise a detection circuit for converting energy received from the radio frequency transmission at multiple frequencies into a logic signal for each frequency received. The beacon detection circuit may comprise logic circuitry for detecting an address of a device to which the beacon is sending an alert. The beacon detection circuit may comprise logic circuitry for combining the logic signals to detect addresses of a class of devices to which the beacon is sending an alert.

The radio frequency transmitter may transmit data including at least one of a device identifier, times at and durations for which the wireless communication subsystem on a device must be turned on, base station identifier, base station location, additional authentication information, and data to be used in subsequent wireless communication with the base station. The data may be used in subsequent wireless communication, and may include data to be used in subsequent communication, including at least one of security keys or passwords.

The beacon may be an ultrasound transmitter, and the beacon detection circuit may comprise a passive ultrasound detection circuit for receiving signals from the ultrasound transmitter.

The beacon detection circuit may comprise circuitry to compare an identifier in a signal received from the beacon with device identification of the mobile device. The beacon may be a radio frequency transmitter, and the beacon detection circuit may comprises a low power receiver for receiving signals from the radio frequency transmitter.

The mobile device may comprises a device selected from the group consisting of a wrist watch, a PDA, and a cell phone.

The invention is also directed to a mobile device for use in a mobile data communications system having at least one base station, and a beacon, the mobile device comprising a wireless communication subsystem for communicating with the base station, and a beacon detection circuit in a mobile device for performing at least one of activating the wireless communication subsystem in the mobile device and alerting a user of the mobile device to conduct communication with a base station, when the beacon is received by the beacon detection circuit. Preferably, the beacon is a radio frequency transmitter, and the beacon detection circuit comprises a passive detection circuit for converting energy received from the radio frequency transmitter to a logic signal. The passive detection circuit may comprise an antenna, a passive energy converter, and a capacitor for storing energy from the passive energy converter. When the beacon is a radio frequency transmitter, the beacon detection circuit may comprise a low power receiver for receiving signals from the radio frequency transmitter. The device may be configured as one of a wrist watch, a PDA, a cell phone, or device having more than one of these functions.

If the beacon comprises a transmitter for transmitting a radio frequency transmission at multiple frequencies, the beacon detection circuit may comprise a detection circuit for converting energy received from the radio frequency transmission at multiple frequencies into a logic signal for each frequency received. The beacon detection circuit may comprise logic circuitry for detecting an address of a device to which the beacon is sending an alert. The beacon detection circuit may comprise logic circuitry for combining the logic signals to detect addresses of a class of devices to which the beacon is sending an alert.

The transmitter may transmit data including at least one of a device identifier, times at and durations for which the wireless communication subsystem on a device must be turned on, base station identifier, base station location, additional authentication information, and data to be used in subsequent wireless communication with the base station. The data may include at least one of security keys or passwords.

The invention is also directed to a method for operating a mobile data communications system having at least one base station and at least one mobile device, comprising monitoring for at least one of proximity to a base station of the at least one mobile device and an alert from a beacon; and performing at least one of activating a wireless communication subsystem in the at least one mobile device for communicating with the base station when in proximity to a base station, or in response to the alert, and providing an alert to a user of the mobile device that there is a message to be received. The monitoring may comprise detecting a beacon signaling the presence of a base station; and activating the wireless communication subsystem in the mobile device when the beacon is detected by the device.

The method may further comprise placing on the beacon a signal containing an address of a mobile device; and activating the wireless communication subsystem in a mobile device when the beacon is detected by the device and the beacon contains an address of the mobile device.

The method may further comprise placing on the beacon a signal containing an address indicative of a class of mobile devices; and activating the wireless communication subsystem in a mobile device when the beacon is detected by the mobile device and the beacon contains the address indicative of a class of mobile devices to which the device belongs.

The method may further comprise providing at least one of visual indication, a tactile indication and an audio indication, to a user of the device that an alert from a beacon has been detected.

The method may further comprise ascertaining a state of charge of a battery powering the device when the beacon has been detected.

When the state of charge of the battery is low, the method may further comprise activating the wireless communication subsystem upon command of a user of the device. If the state of charge of the battery changes so that it is not low, the method further comprises again monitoring for proximity of a base station to the at least one mobile device.

The method may further comprise establishing a polling schedule for the transfer of data between the base station and the at least one mobile device. If communication between the base station and the at least one mobile device is lost, the method may further comprise monitoring for proximity of a base station to the at least one mobile device.

The method may further comprising providing an indication to a user of the mobile device that communication between a base station and the mobile device is not established. Preferably, when the mobile device is not in proximity to a base station, the wireless communication subsystem is turned off. Preferably, the wireless communication subsystem is turned on only when a mobile device in which it is contained is in proximity to a base station.

The invention is also directed to an article of manufacture comprising a computer usable medium having computer readable program code means embodied therein for causing a mobile data communications system having at least one base station and at least one mobile device, to execute steps comprising monitoring for at least one of proximity of a base station to the at least one mobile device and an alert from a beacon; and performing at least one of activating a wireless communication subsystem in the at least one mobile device for communicating with the base station when in proximity to a base station, or in response to the alert, and providing an alert to a user of the mobile device that there is a message to be received. The article may further comprise computer code for performing the monitoring by detecting a beacon associated with a base station; and activating the wireless communication subsystem in the mobile device when the beacon is detected by the device.

The article may further comprise computer code for causing the device to provide an indication to a user of the device that a beacon has been detected. The article may further comprise computer code for ascertaining a state of charge of a battery powering the device when the beacon has been detected.

The article may further comprise computer code for activating the wireless communication subsystem upon command of a user of the device when the state of charge of the battery is low. Computer code for again monitoring for proximity of a base station to the at least one mobile device, if a state of charge of the battery changes so that it is not low may also be included.

The article may further comprise computer code for establishing a polling schedule for the transfer of data between the base station and the at least one mobile device, as well as computer code for monitoring for proximity of a base station to the at least one mobile device if communication between the base station and the at least one mobile device is lost.

The computer code of the article may causing the mobile device to provide an indication to a user of the mobile device that communication between a base station and the mobile device is not established as well as computer code for turning off the wireless communication subsystem when the mobile device is not in proximity to a base station. The article may further comprising computer code for turning on the wireless communication subsystem only when a mobile device in which it is contained is in proximity to a base station.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a block diagram of a prior art mobile communications device;

FIG. 2 is a block diagram of the RF wireless communication subsystem of the device of FIG. 1;

FIG. 3 is a block diagram of a mobile communications device in accordance with the invention;

FIG. 4 is a block diagram of a first embodiment the RF sensing circuitry of the device of FIG. 3;

FIG. 4A is a block diagram of a second embodiment the RF sensing circuitry of the device of FIG. 3;

FIG. 5 is a block diagram of a system utilizing the invention, including a base station structure;

FIG. 6 is a wireless coverage map of the system in accordance with the invention; and

FIG. 7 is a flow chart of the operation of a mobile device in accordance with the invention.

FIG. 8 is a block diagram of a portion of an additional embodiment of a mobile communications device in accordance with the invention.

FIG. 9 is a flow chart of the operation of the embodiment of FIG. 8.

FIG. 10 is a block diagram of yet another embodiment of a mobile communications device in accordance with the invention.

FIG. 11 is a flow chart of the operation of the device of FIG. 10.

FIG. 12 is a wireless coverage map of the system wherein a different approach is used to alert a mobile device to receive communication.

### DESCRIPTION OF THE INVENTION

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

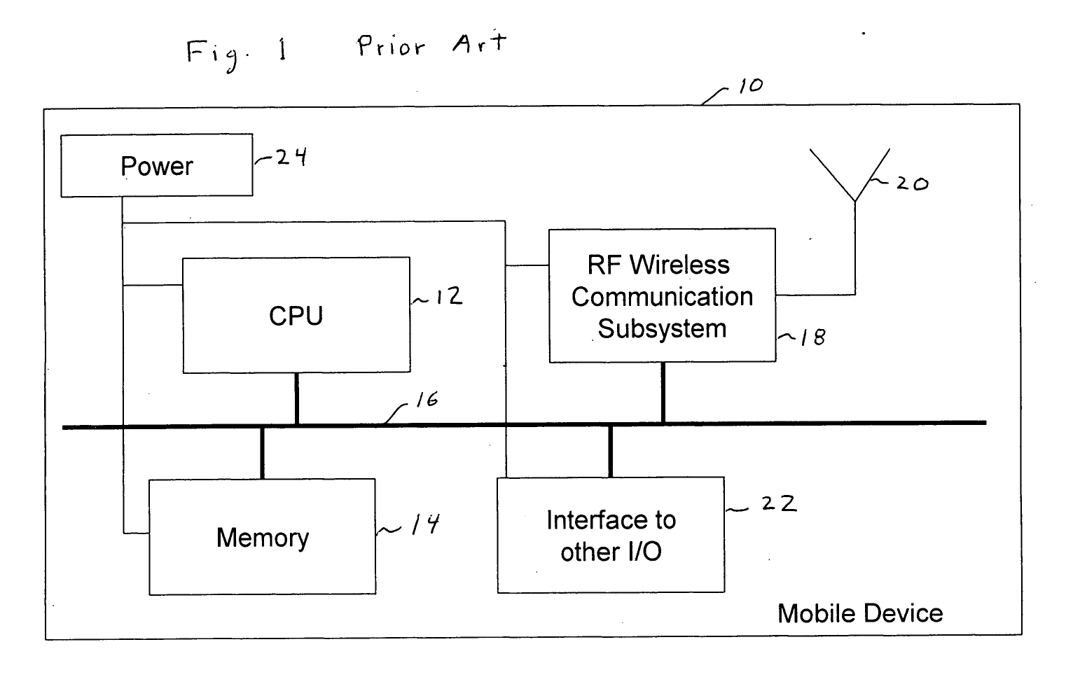

Referring to FIG. 1, a prior art mobile communications device 10 includes a main CPU 12 and a memory 14 that are interconnected by a system bus 16. The memory 14 may contain computer code which implements the method of the present invention. An RF wireless communication module 18 has an antenna 20 to communicate data with the external world. In addition, there may be other I/O devices that have respective interfaces 22. Power, typically from a battery 24, is distributed to all of the subsystems shown in FIG. 1.

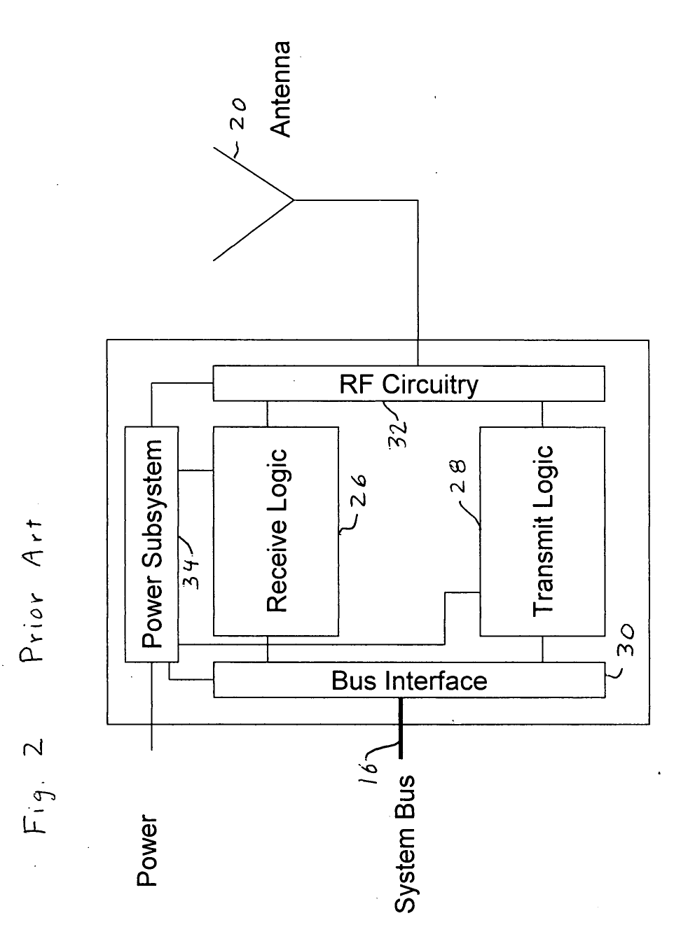

Referring to FIG. 2, the internals of the RF communication subsystem 18 include a separate receive logic 26 and a transmit logic 28, which process incoming and outgoing data, respectively. In addition there is a bus interface 30 that communicates with the system bus 16. There is also radio frequency circuitry 32 connected to the antenna 20 and to both the receive logic 26 and the transmit logic 28. Internally, power is distributed to all of the different portions of the RF communication subsystem by a power subsystem 34.

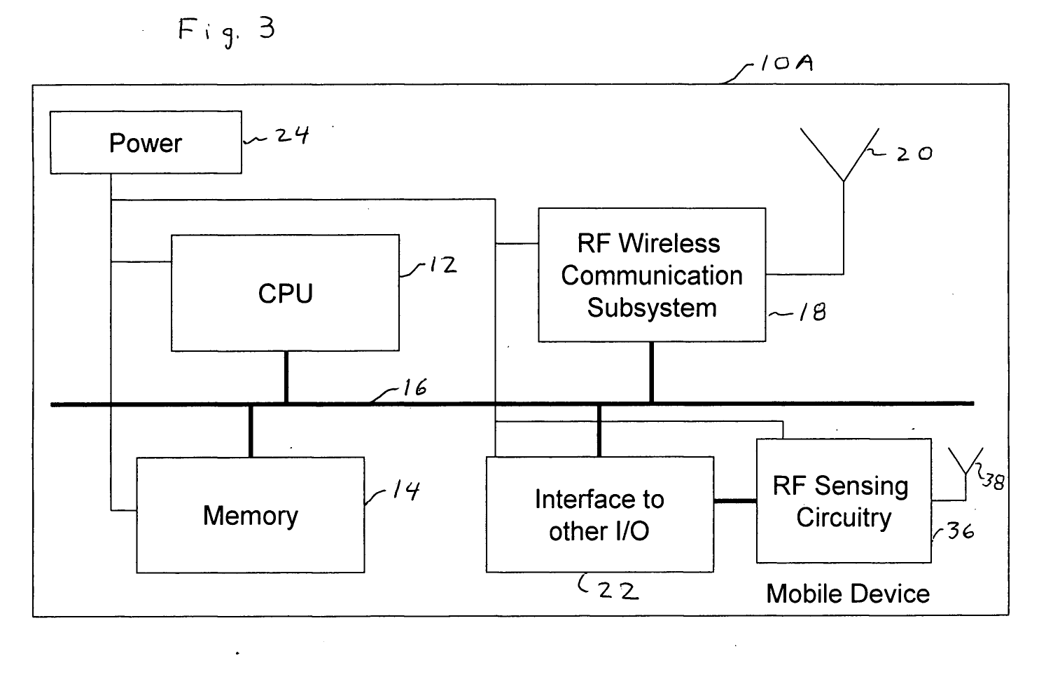

Referring to FIG. 3, the prior art device 10 of FIG. 1 is modified to provide a device 10A in accordance with the invention, by adding an RF sensing circuit 36 to the mobile device. The RF sensing circuit may have its own antenna 38. RF sensing circuit 36 may interface to the device 10A via interface 22.

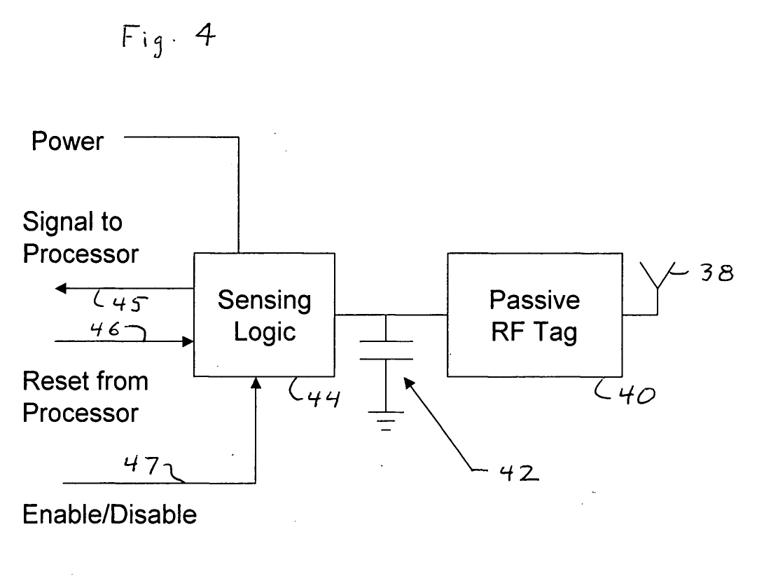

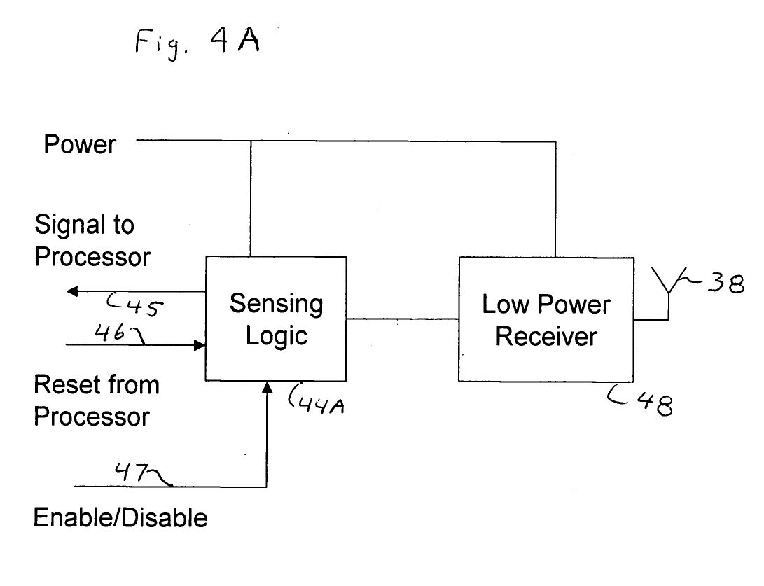

Referring to FIG. 4, in a first embodiment, the RF sensing circuitry is connected to antenna 38 and may include a passive RF tag 40 that converts energy that it collects from the antenna 38 to charge a capacitor 42. Passive RFID tags exist today that can collect energy from the antenna (radiated from a RFID tag reader), and use that energy to send a bit string back to the reader. The present invention may use a simpler operation, namely just charging the capacitor. The passive RF tag 40 does not consume any energy, and needs no connection to a power source. Sensing logic 44 monitors the charge on capacitor 42 and when the charge on the capacitor exceeds a certain threshold, it sends a signal on line 45 to the processor (CPU 12 of FIG. 3) indicating this fact. The processor may issue a reset signal on line 46 that causes the sensing logic 44 to discharge the capacitor 42 and returns the sensing logic 44 to a condition in which it is again ready for sensing. A control signal from the processor (CPU 12 of FIG. 3), is provided to the sensing logic 44 on a line 47 to control whether the sensing logic is enabled or disabled.

FIG. 4A is similar to FIG. 4, except that instead of a passive RF tag, a very low power receiver 48 is used. Examples of such low power receivers include narrow band receivers, including receivers having very stable high quality factor tuning components tuned precisely to a particular frequency. Receiver 48 may be, for example, an FM radio receiver tuned to one specific frequency) that consumes far less energy than the receiver which is normally used for two way wireless communication. In effect, this approach utilises a two level RF communication mechanism which includes a low power (or zero power) radio receiver that is always on and is used to sense the presence of a base station. When such a base station is sensed, this first level RF receiver 48 notifies the mobile device 10A, by way of the signal on line 45, so that the mobile device can, by way of CPU 12 (FIG. 3), turn on its main (second level) two way RF communication circuitry (RF communication subsystem 18 of FIG. 3) to accomplish any data transfers that are required. In this context, by low power, it is meant that the amount of power consumed is low enough that there is negligible effect on battery life, even if the low power receiver is operated continuously. As in FIG. 4, a control signal from the processor (CPU 12 of FIG. 3), is provided to the sensing logic 44A on a line 47 to control whether the sensing logic is enabled or disabled.

Instead of RF sensing mechanisms, other mechanisms such as audio detection, ultrasound detection, etc., could be applied as well.

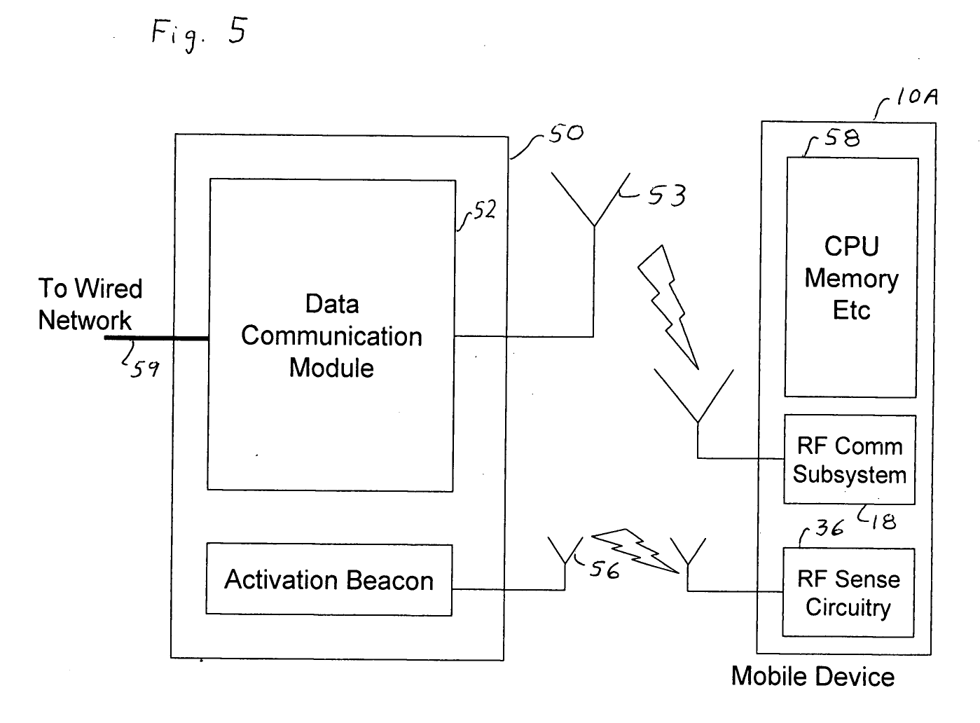

Referring to FIG. 5, each base station 50 with which a device 10A may communicate is equipped with a data communication module 52, attached to an antenna 53, that can communicate with the RF communication subsystem 18 of the mobile device 10A. In addition, each base station 50 may have an activation beacon 54 that is connected to a beacon antenna 56. Beacon 54 periodically transmits bursts of energy that are used to trigger the RF sensing circuitry 36 in a mobile device 10A to charge up the capacitor and signal the CPU as described with respect to FIG. 4. or to trigger the very low power receiver 48 as described with respect to in FIG. 4A. It is noted that for simplicity, the remainder of the components of the device 10A not specifically discussed with respect to FIG. 5 are represented by a single block 58. Base station 50 is connected by a bus 59 to a wired network, such as a telephone system or the Internet, or both which communicates data to and from mobile device 10A.

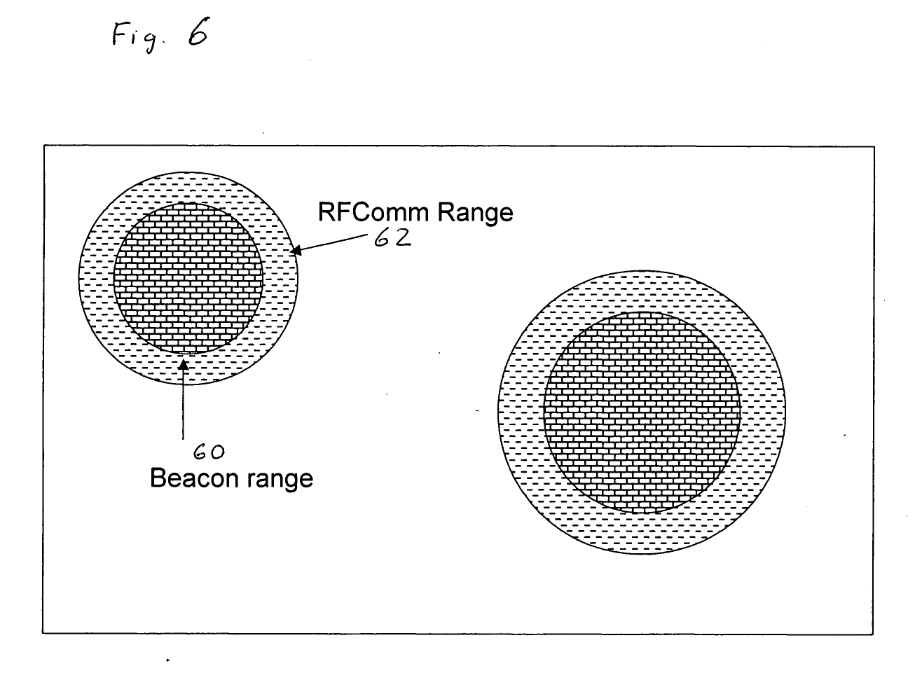

In FIG. 5, the activation beacon is shown as being part of the base station for simplicity. However the activation beacon can be a distinct from the base station so long as the ranges of activation beacon is almost the same as the RF Communication range as shown in FIG. 6.

Referring to FIG. 6, the energy levels, antennas and circuit sensitivities in the base stations are configured so that the range of the activation beacon 60 is slightly shorter than the range 62 within which actual data communication can take place.

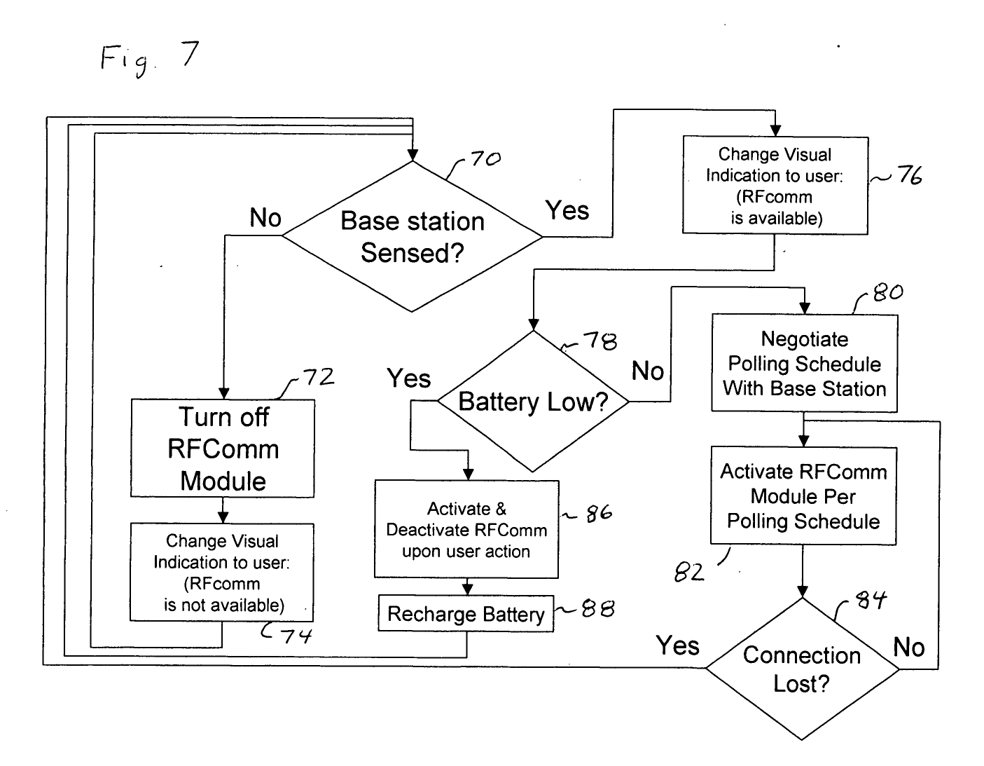

FIG. 7 is a flow chart representing the operation of each mobile device 10A in accordance with the invention. At 70 a determination is made as to whether a base station as been sensed. If the answer is No, (the mobile device is out of range of the base station) at 72, the CPU turns off the RFComm subsystem 18 or module comprehensively saving energy communication energy. A visual indication (such as an indicator on a portion of a liquid crystal display, or other display device which does not consume a great deal of energy) is provided to the user on mobile device 10A that RFComm is not available, at 74, and the system waits at 70. Alternative indication means providing audio or tactile means of alert are also possible. When the sense circuitry notices that there is a base station nearby (a Yes at 70), the visual indication (or alternative indication) to the user is changed at 76. A check of remaining battery energy is then made at 78. If there is sufficient energy in the battery a polling schedule is negotiated with the base station at 80. The RFComm module or subsystem 18 is awakened periodically at 82 as per the polling schedule. If during one wake up event, the mobile device 10A is unable to connect to the base station, the connection has been lost (a Yes at 84) the device 10A then returns to 70 to check whether it is in range of a base station. If at 78, the battery is low, the mobile device 10A does not automatically activate the RFComm module or subsystem 18. Instead, as represented at 86, it only activates and deactivates the RF module in response to explicit user actions, such as, for example, operation of a control on mobile device 10A. There may be additional visual indications to the user (not shown in FIG. 7) that automatic RFComm activation is not being done. If the battery is recharged, as represented by 88, or the mobile device is connected to a battery charger or other power supply, the mobile device 10A returns to the state represented at 70, and again monitors for an in-range base station.

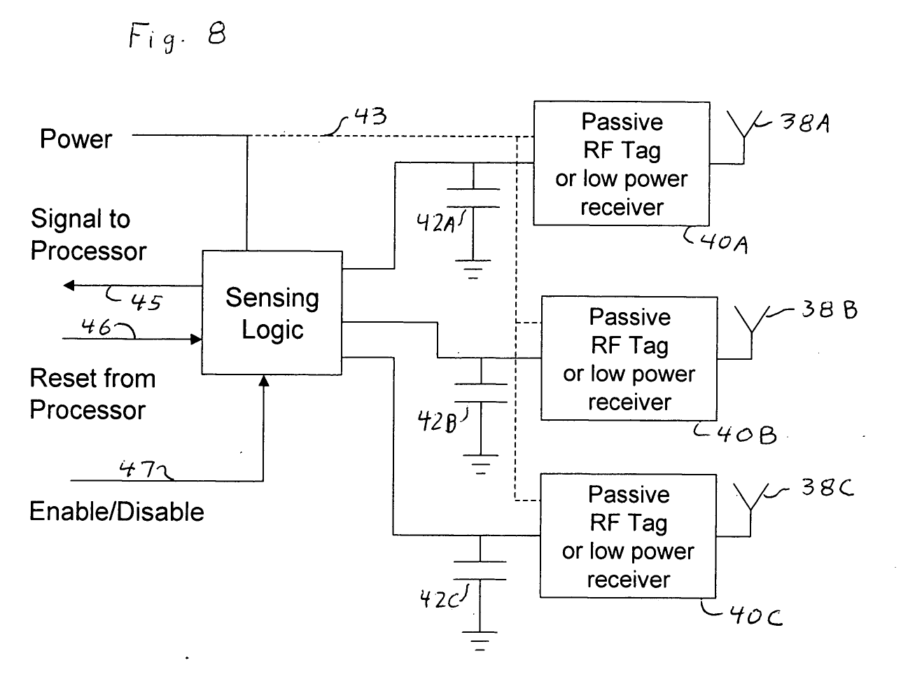

In FIG. 8 multiple receivers 40A, 40B and 40C, preferably in the form of passive RF tags, connected to integral antennas 38A, 38B and 38C respectively, operate at different frequencies. Sensing logic 44C monitors multiple capacitors 42A, 42B and 42C that are charged in response to RF energy detected at the multiple frequencies by RF tags 40A, 40B and 40C, respectively. The charges on the multiple capacitors can thus be used to detect whether the signal from the beacon is addressing the particular mobile device. Thus, the base station now has the ability to wake up a specific mobile device by transmitting on some combination of frequencies. In this case, with three tags, three categories of mobile nodes can be addressed. Using encoding up to seven mobile devices or nodes can be addressed. The combination of 0,0,0 cannot be used since this combination is the one that obtains when a device is not proximal to a base station, or when no device is being addressed. Instead of three tags a larger number of tags may be used. In that case, the pattern of tags that are triggered can be used to indicate the actual mobile device, instead of just a class or category.

In a manner similar to that of FIG. 4A, multiple receivers 40A, 40B and 40C, may each be low power receivers tuned to specific narrow frequency bands, instead of passive RF tags. In that case, power is supplied to each of receivers along a power line 43, shown in dotted lines because it is not needed when passive RF tags are used.

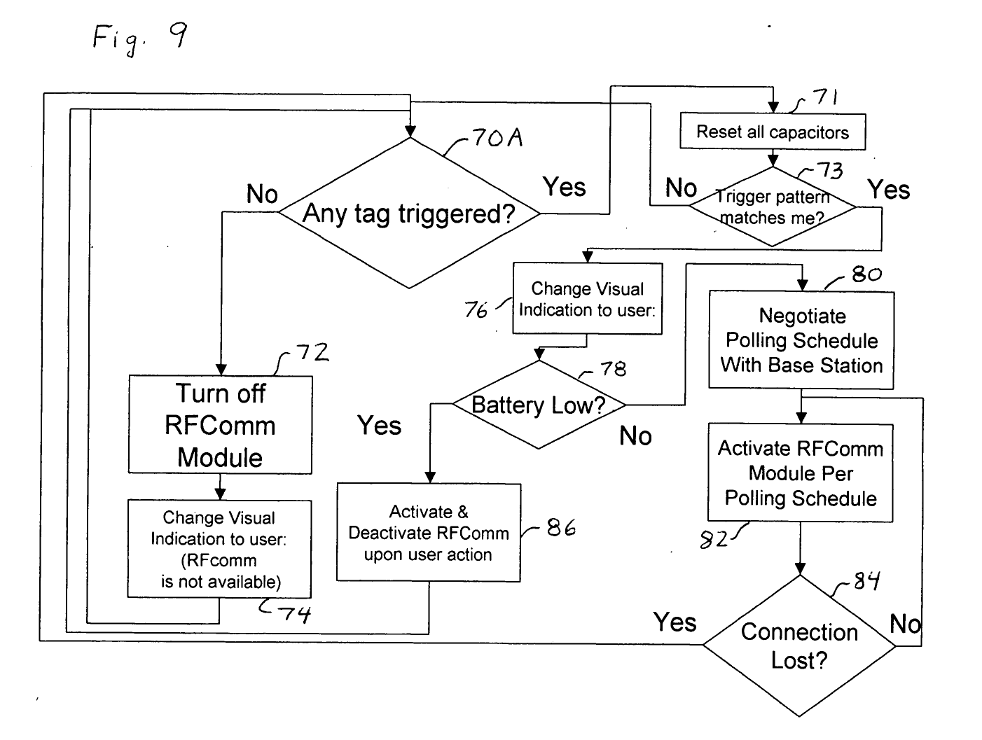

FIG. 9 is a flow chart illustrating the manner of operation of a mobile device which is configured with multiple frequency sensing circuitry of FIG. 8. in many respects it is similar to that of FIG. 7, and its operation will be discussed only to the extent that it differs from that of FIG. 7. At 70A, the sensing logic waits until at least one tag is triggered. When this happens, the mobile device is in the vicinity of a base station. If so, it resets all its capacitors at 71, and wait for the next trigger at 73. At this point it can determine which tags were triggered. Each mobile device is configured with a trigger pattern that is known to the associated infrastructure. Several mobiles devices can have the same trigger pattern, thus defining a class of mobile devices. The infrastructure can contain a database which defines which mobile device or devices are to receive a communication. The beacons are thus caused to transmit on appropriate signal frequencies so that the device or devices in question are “awakened”. Once awake and a polling schedule established at 80, the infrastructure has information indicating that the mobile device in question is responsive, and does not need to transmit the wake-up pattern again. The coverage map for this arrangement may be identical to that of FIG. 6.

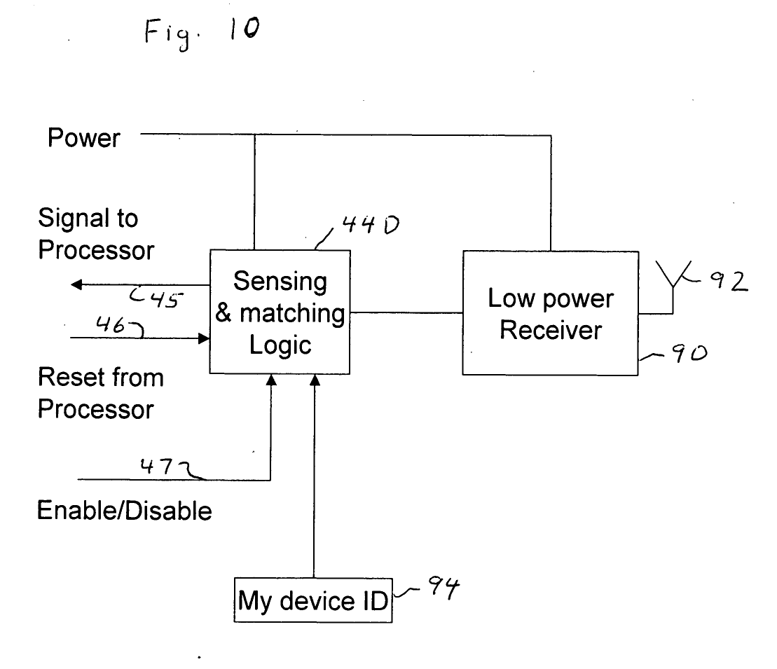

By adding additional functionality to the low power receiver, the instances where the mobile device wakes up only in situations when there is no actual message for the mobile device, can be eliminated. In FIG. 10, the wake up signal includes a device identifier that is decoded by the low power receiver. When this level of capability is present in the low power receiver then the signaling beacon does not need to be tied to the transmit range of the two-way communication module. It can have a much wider coverage area. In specific, one may consider using an FM radio station to transmit the wake up signal. The radio frequency transmitter may transmit data including at least one of a device identifier, times at and durations for which the wireless communication subsystem on a device must be turned on, base station identifier, base station location, additional authentication information, data to be used in subsequent wireless communication with the base station. The data, which may be used in subsequent wireless communication may include at least one of security keys or passwords.

Thus, in FIG. 10 a low power receiver 90, connected to an integral antenna 92, receives a specific bit pattern that is extracted from the transmitted signal. This specific bit pattern is compared, by logic 44D, to device specific identification information, in a device identifier memory 94, to determine whether the infrastructure is trying to communicate with this specific mobile device, rather than a class of mobile devices as in the case in FIG. 8. The identifier can be some sort of unique identifier assigned during manufacture of the mobile device.

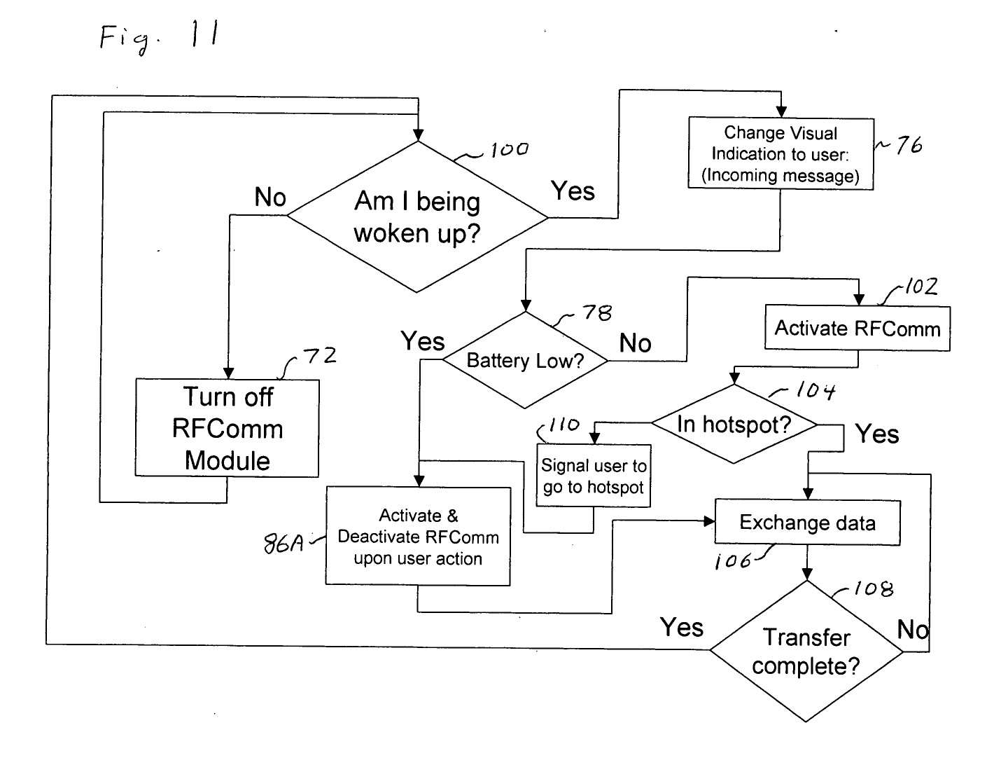

FIG. 11 illustrates the operation of a system in accordance with FIG. 10 When a dedicated wake up mechanism is available the operation is much simpler. At 100, the mobile device waits for a wake up signal.

If none is received, the communications subsystem 18 (FIG. 3) is turned off at 72. If a wake up signal is received, the receiver of communications subsystem 18 is turned on, and at 104 determines whether the mobile device is in the vicinity of a hot spot. If so, the message is received at 106, and when communication has been completed at 108, the communications subsystem returns to its off state. If at 104, the mobile device is not at a hot spot, the user is informed at 110 that there is an incoming message and the user should go to a hot spot. Once at the hotshot, at 86A, the user provides an input to the mobile device indicating that he is at a hot spot, and the mobile device then activates its communications subsystem and exchanges data at 106.

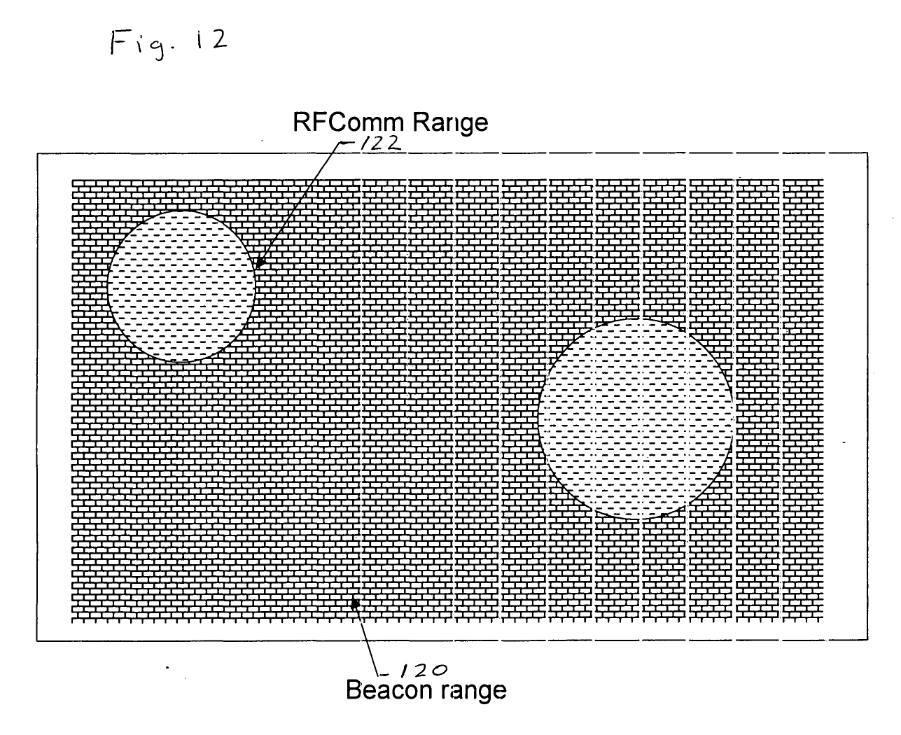

FIG. 12 illustrates a approach wherein a relatively long range beacon, having a range represented by 120, is utilised. As noted above a, local radio station may have signals placed on its carrier along with its usual programs so that it serves as a beacon for, also by way of example, wrist watches, which may be alerted to attempt communication with their customary base station, or to advise the wearer to change position to a location where wireless communication can be received on the mobile device, as within a range represented by 122. In addition to a local radio station, such signals may be provided by, for example, satellite radio channels such as those used by XM® or Sirus®. Cell phone technologies such as 3G, GSM etc. may also be used, wherein the beacon is transmitted by one or more cell phone base stations. In these cases, the beacon range can far exceed the communication range with the mobile device. However, as noted in the embodiment of the invention described above with respect to FIG. 11, the mobile device can provide an alert to the user that it is necessary to find a hot spot in order to communicate.

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

1. A mobile data communications system having at least one base station and at least one mobile device, comprising:
a wireless communication subsystem in each mobile device for communicating with said at least one base station,
a beacon for signaling at least one of a presence of a base station and a need for a mobile device to associate or communicate with a base station; and
a beacon detection circuit in a mobile device for performing at least one of activating said wireless communication subsystem in said mobile device, and alerting a user of said mobile device to conduct communication with a base station, when said beacon is received by said beacon detection circuit.

2. The system as recited in claim 1, wherein said beacon has a range less than that of said wireless communication subsystem, and said wireless communication subsystem is activated when said mobile device is in proximity to a location of a beacon.

3. The system of claim 2, wherein said beacon transmits data indicative of a class of mobile devices to which messages are to be sent.

4. The system of claim 1, wherein said beacon range is larger than that of said wireless communication subsystem.

5. The system of claim 4, wherein said beacon provides an indication of the particular mobile devices to which a message is to be sent.

6. The system as recited in claim 1, wherein said beacon comprises a signal transmitted by one of a broadcast station, a satellite radio channel, and a cell phone base station, and said beacon detection circuit is configured for receiving said signal.

7. The system as recited in claim 1, wherein said beacon is a radio frequency transmitter, and said beacon detection circuit comprises a passive detection circuit for converting energy received from said radio frequency transmitter to a logic signal.

8. The system as recited in claim 7, wherein said passive detection circuit comprises an antenna, a passive energy converter, and a capacitor for storing energy from said passive energy converter.

9. The system as recited in claim 1, wherein said beacon comprises a transmitter for transmitting a radio frequency transmission at multiple frequencies and said beacon detection circuit comprises a detection circuit for converting energy received from said radio frequency transmission at multiple frequencies into a logic signal for each frequency received.

10. The system as recited in claim 9, wherein said beacon detection circuit comprises logic circuitry for detecting an address of a device to which the beacon is sending an alert.

11. The system as recited in claim 9, wherein said beacon detection circuit comprises logic circuitry for combining said logic signals to detect addresses of a class of devices to which the beacon is sending an alert.

12. The system as recited in claim 9, wherein said radio frequency transmitter transmits data including at least one of a device identifier, times at and durations for which said wireless communication subsystem on a device must be turned on, base station identifier, base station location, additional authentication information, and data to be used in subsequent wireless communication with the base station.

13. The system as recited in claim 9, wherein data to be used in subsequent wireless communication said data to be used in subsequent communication includes at least one of security keys or passwords.

14. The system as recited in claim 1, wherein said beacon is an ultrasound transmitter, and said beacon detection circuit comprises a passive ultrasound detection circuit for receiving signals from said ultrasound transmitter.

15. The system as recited in claim 1, wherein said beacon detection circuit comprises circuitry to compare an identifier in a signal received from said beacon with device identification of the mobile device.

16. The system as recited in claim 1, wherein said beacon is a radio frequency transmitter, and said beacon detection circuit comprises a low power receiver for receiving signals from said radio frequency transmitter.

17. The system as recited in claim 1, wherein said at least one mobile device comprises a device selected from the group consisting of a wrist watch, a PDA, and a cell phone.

18. A mobile device for use in a mobile data communications system having at least one base station, and a beacon, said mobile device comprising:
a wireless communication subsystem for communicating with said base station, and
a beacon detection circuit in said mobile device for performing at least one of activating said wireless communication subsystem in said mobile device and alerting a user of said mobile device to conduct communication with a base station, when said beacon is received by said beacon detection circuit.

19. The device as recited in claim 18, wherein said beacon is a radio frequency transmitter, and said beacon detection circuit comprises a passive detection circuit for converting energy received from said radio frequency transmitter to a logic signal.

20. The device as recited in claim 19, wherein said passive detection circuit comprises an antenna, a passive energy converter, and a capacitor for storing energy from said passive energy converter.

21. The device as recited in claim 18, wherein said beacon is a radio frequency transmitter, and said beacon detection circuit comprises a low power receiver for receiving signals from said radio frequency transmitter.

22. The device as recited in claim 18, configured as a device selected from the group consisting of a wrist watch, a PDA, and a cell phone.

23. The device as recited in claim 18, wherein said beacon comprises a transmitter for transmitting a radio frequency transmission at multiple frequencies and said beacon detection circuit comprises a detection circuit for converting energy received from said radio frequency transmission at multiple frequencies into a logic signal for each frequency received.

24. The device as recited in claim 23, wherein said beacon detection circuit comprises logic circuitry for detecting an address of a device to which the beacon is sending an alert.

25. The device as recited in claim 23, wherein said beacon detection circuit comprises logic circuitry for combining said logic signals to detect addresses of a class of devices to which the beacon is sending an alert.

26. The device as recited in claim 23, wherein said radio frequency transmitter transmits data including at least one of a device identifier, times at and durations for which said wireless communication subsystem on a device must be turned on, base station identifier, base station location, additional authentication information, and data to be used in subsequent wireless communication with the base station.

27. The device as recited in claim 23, wherein data to be used in subsequent wireless communication said data to be used in subsequent communication includes at least one of security keys or passwords.

28. A method for operating a mobile data communications system having at least one base station and at least one mobile device, comprising:
monitoring for at least one of proximity to a base station of said at least one mobile device and an alert from a beacon; and
performing at least one of activating a wireless communication subsystem in said at least one mobile device for communicating with said base station when in proximity to a base station, or in response to said alert, and providing an alert to a user of said mobile device that there is a message to be received.

29. A method as recited in claim 28, wherein said monitoring comprises:
detecting a beacon signaling the presence of a base station; and
activating said wireless communication subsystem in said mobile device when said beacon is detected by said device.

30. A method as recited in claim 28, further comprising:
placing on said beacon a signal containing an address of a mobile device; and
activating said wireless communication subsystem in a mobile device when said beacon is detected by said device and said beacon contains an address of said mobile device.

31. A method as recited in claim 28, further comprising:
placing on said beacon a signal containing an address indicative of a class of mobile devices; and
activating said wireless communication subsystem in a mobile device when said beacon is detected by said mobile device and said beacon contains said address indicative of a class of mobile devices to which said device belongs.

32. A method as recited in claim 28, further comprising providing at least one of visual indication, a tactile indication and an audio indication, to a user of said device that an alert from a beacon has been detected.

33. A method as recited in claim 28, further comprising ascertaining a state of charge of a battery powering said device when said beacon has been detected.

34. A method as recited in claim 28, wherein when said state of charge of said battery is low, activating said wireless communication subsystem upon command of a user of said device.

35. A method as recited in claim 34, wherein if a state of charge of said battery changes so that it is not low, the method further comprises again monitoring for proximity of a base station to said at least one mobile device.

36. A method as recited in claim 28, further comprising establishing a polling schedule for the transfer of data between said base station and said at least one mobile device.

37. A method as recited in claim 28, wherein if communication between said base station and said at least one mobile device is lost, the method further comprises monitoring for proximity of a base station to said at least one mobile device.

38. A method as recited in claim 28, further comprising providing an indication to a user of said mobile device that communication between a base station and said mobile device is not established.

39. A method as recited in claim 28, wherein when the mobile device is not in proximity to a base station, said wireless communication subsystem is turned off.

40. A method as recited in claim 28, wherein said wireless communication subsystem is turned on only when a mobile device in which it is contained is in proximity to a base station.

41. An article of manufacture comprising a computer usable medium having computer readable program code means embodied therein for causing a mobile data communications system having at least one base station and at least one mobile device, to execute steps comprising:
monitoring for at least one of proximity of a base station to said at least one mobile device and an alert from a beacon; and
performing at least one of activating a wireless communication subsystem in said at least one mobile device for communicating with said base station when in proximity to a base station, or in response to said alert, and providing an alert to a user of said mobile device that there is a message to be received.

42. An article as recited in claim 41, further comprising computer code for performing said monitoring by:
detecting a beacon associated with a base station; and
activating said wireless communication subsystem in said mobile device when said beacon is detected by said device.

43. An article as recited in claim 41, further comprising computer code for causing said device to provide an indication to a user of said device that a beacon has been detected.

44. An article as recited in claim 41, further comprising computer code for ascertaining a state of charge of a battery powering said device when said beacon has been detected.

45. An article as recited in claim 44, further comprising computer code for activating said wireless communication subsystem upon command of a user of said device when said state of charge of said battery is low.

46. An article as recited in claim 45, further comprising computer code for again monitoring for proximity of a base station to said at least one mobile device, if a state of charge of said battery changes so that it is not low.

47. An article as recited in claim 41, further comprising computer code for establishing a polling schedule for the transfer of data between said base station and said at least one mobile device.

48. An article as recited in claim 47, further comprising computer code for monitoring for proximity of a base station to said at least one mobile device if communication between said base station and said at least one mobile device is lost.

49. An article as recited in claim 41, further comprising computer code for causing said mobile device to provide an indication to a user of said mobile device that communication between a base station and said mobile device is not established.

50. An article as recited in claim 41, further comprising computer code for turning off said wireless communication subsystem when the mobile device is not in proximity to a base station.

51. An article as recited in claim 41, further comprising computer code for turning on said wireless communication subsystem only when a mobile device in which it is contained is in proximity to a base station.
